(19) United States
(12) Patent Application Publication
(10) Pub. No.: US 2026/0265019 A1
(43) Pub. Date: Sep. 10, 2026

(54) ROTARY LOCK

(71) Applicant: INVENTIO AG, Hergiswil (CH)

(72) Inventor: Ryan Bloomgren, Benson, NC (US)

(21) Appl. No.: 19/167,195

(22) PCT Filed: Mar. 4, 2024
(86) PCT No.: PCT/EP2024/055564

§ 371 Date: Sep. 19, 2025

(30) Foreign Application Priority Data
Mar. 20, 2023 (EP) 23162865.2

(51) Int. Cl. B66B 1/46

(52) U.S. Cl. CPC B66B 1/466; B66B 1/463

(57) ABSTRACT

A rotary lock for a car operating panel (COP) of an elevator car, is disclosed. The rotary lock includes a housing removably disposed on a touch sensitive portion of the COP. The housing includes an inner surface adapted to receive a blade portion of a key. The rotary lock includes at least one contact element disposed on an outer surface of the housing. During rotation of the housing, the at least one contact element contacts at least one touch sensitive portion of the COP to form at least one capacitive coupling indicative of a selection of at least one predefined function of the elevator car.

### FIELD

The present invention generally relates to rotary locks for elevator cars. More particularly, the present invention relates to a rotary lock for a car operating panel (COP) of an elevator car. The invention also relates to the elevator car and a kit having such rotary locks.

### BACKGROUND

Elevators are commonly used for vertical transportation in buildings thereby performing an essential function in multi-story commercial or residential buildings. Typically, elevator systems contain at least one elevator car that can be moved up and down in an elevator shaft. The car can be moved by means of a drive unit via suspension means, for example in the form of suspension cables or suspension belts. Since elevators are an important working component of commercial or residential multi-storied buildings, regular maintenance and service checks are desirable to prevent elevator malfunction or damage. Inconsistent maintenance of elevators can lead to unforeseen stoppages and malfunctions that cause inconvenience to large numbers of people during peak hours in commercial buildings.

During the service check of the elevator system, elevator keys are used to grant access to restricted areas in the elevator systems, such as the control room, machine room, or certain floors of the multi-story building. They are typically used by maintenance personnel, building engineers, or security personnel to perform maintenance, repair, or security tasks. Elevator keys can also be used to manually control the elevator in emergency situations by fire and safety personnel. In existing elevator systems, different keys are provided to mate with a corresponding lock for accessing a particular function of the elevator system such as access to an independent hoist way, a start-stop function, and the like.

Elevator keys couple with mating surfaces within a corresponding lock and unlock using mechanical lock assemblies. Mechanical lock assemblies, for elevator keys can present several disadvantages, particularly in terms of maintenance and reliability. Mechanical components of the assemblies are prone to wear and tear, and regular maintenance and upkeep are required to keep the system functioning properly. Mechanical failures can result in breakdowns or malfunctions, making the elevator key system unreliable. Furthermore, mechanical lock assemblies can be complex and difficult to repair, requiring personnel having specialized skills and knowledge, leading to high repair and maintenance costs. The installation and setup process for mechanical lock assemblies can also be time consuming, leading to increased downtime and decreased productivity. Additionally, mechanical assemblies may not have the same level of functionality and versatility as electronic systems, limiting the capabilities and functionality of the elevator key.

JP-06156889 discloses a control apparatus that has only a small transverse dimension having actuating elements, such as buttons disposed on a front surface. A separate auxiliary actuating element, which is a chip card cooperating with a corresponding insert in the control apparatus, is used instead of a mechanically acting key. This insert has a slot-shaped recess in which the card can be inserted by a translational movement parallel to the front surface. The disadvantage of this control apparatus resides in the fact that the chip card is not suitable as an auxiliary actuating element in the same way as a mechanical key. This is because the chip card can be more easily damaged in handling and storage than a metallic key and it requires for its function costly electronic auxiliary equipment. A further disadvantage of the chip card relative to a key resides in the fact that when a key is inserted it is recognisable at the key position in what way it acts or should act, which is not the case with the chip card.

### SUMMARY

Among other things, there is a need for an improved elevator lock and key system, which is less prone to wear and tear and is therefore reliable. Moreover, it is desirable for the improved elevator lock and key system to be easily installed without being prohibitively expensive to implement. Preferably, the total cost of implementation of the improved elevator lock and key system must be low and inexpensive to replace. Furthermore, there is a need for an improved elevator lock and key system to enhance the functionality of the elevator system. Preferably, a single lock adapted to provide multiple functionalities is desired.

At least one of the demands mentioned can be met with the subject matter according to any of the independent claims. Advantageous embodiments are defined in the dependent claims and in the following description.

It is the object of the invention to submit a rotary lock for a car operating panel (COP) of an elevator car for accessing predefined functions associated with a maintenance session, a repair session, or an emergency session of the elevator car, with minimal space requirements, reduced costs, and to eliminate the abovementioned associated shortcomings. According to the invention, this object is solved by the rotary lock having the features as disclosed below.

According to a first aspect of the invention, the rotary lock for the car operating panel (COP) of the elevator car, is disclosed. The rotary lock includes a housing and at least one contact element. The housing is removably disposed on a touch sensitive portion of the COP. Moreover, the housing includes an inner surface adapted to receive a blade portion of a key. The at least one contact element is disposed on an outer surface of the housing. During rotation of the housing, the at least one contact element contacts at least one touch sensitive portion of the COP to form at least one capacitive coupling indicative of a selection of at least one predefined function of the elevator car.

As used herein, the term “the at least one contact element” refers to a conductive material such as a metal, a conductive ink, or a conductive resin capable of forming a capacitive coupling with the at least one touch sensitive portion of the COP. In an embodiment, the at least one contact element is disposed on the outer surface of the housing of the rotary lock instead of the key. Advantageously, this feature reduces the cost of producing or replacing the key.

As used herein, the term “at least one predefined function” may be construed to include, but is not limited to, access to an independent hoist way, access to restricted floors, user control to control a movement of the elevator car to specific floors, enabling maintenance functions such as recalling the elevator car to a specific floor or shutting off power to the elevator car, service functions such as priority service, in-car inspection, independent service, run/stop switch, code blue/medical emergency access, firefighters operation access, sabbath service, car light on/off/speed, and car fan on/off/speed switches. Since a single rotary lock can be used to access multiple functions of the elevator car, the space requirements are advantageously minimized. Moreover, the replacement time of a faulty or malfunctioning rotary lock is advantageously reduced since only a single rotary lock may need to be replaced.

Preferably, the housing of the rotary lock is rotatable about an axis (X-X′) perpendicular to an axis (Y-Y′) of the COP.

In an embodiment according to the disclosure, the inner surface of the housing of the rotary lock defines at least one first interlocking element adapted to couple with at least one second interlocking element defined on the blade portion of the key.

Preferably, the housing of the rotary lock is adapted to rotate about the axis (X-X′) and retract along the axis (X-X′) towards the COP only in response to the at least one first interlocking element of the housing coupling with the at least one second interlocking element of the blade portion of the key.

Preferably, the housing of the rotary lock is adapted to be removably fixed to the COP through an adhesive. In an embodiment, the adhesive used may include, but is not limited to, a synthetic adhesive, a hot-melt adhesive, a pressure-sensitive adhesive, and an ultraviolet-cured adhesive. The inclusion of the adhesive for removably fixing the rotary lock reduces the cost associated with installation of the rotary lock in comparison to conventional mechanical fixing methods using fasteners.

In an embodiment, a degree of rotation of the housing of the rotary lock about the axis (X-X′) is preset based on a type of the inserted key. This means for a first type of key, the degree of rotation of the housing may be restricted to less than 45 degrees about the axis (X-X′). Alternatively, for a second type of key, the degree of rotation of the housing may be restricted to greater than 45 degrees but less than 90 degrees about the axis (X-X′) and so on. Advantageously, different keys corresponding to different predefined functions of the elevator car for a single rotary lock may therefore be designed.

In an embodiment, the at least one contact element of contacts the touch sensitive portion of the COP corresponding to the preset degree of rotation to form a capacitive coupling indicative of the selection of the predefined function associated with the type of the inserted key. A controller or microprocessor of the COP may be configured to identify the selected predefined function and accordingly provide access to the selected predefined function. Advantageously, different keys corresponding to different predefined functions of the elevator car for a single rotary lock may therefore be designed.

Possible features and advantages of embodiments of the invention can be considered, among other things and without limiting the invention, to be dependent upon the concepts and findings described below.

According to a second aspect of the invention, an elevator car, is disclosed. The elevator car includes at least one car operating panel (COP), at least one rotary lock, and a key. The at least one rotary lock includes a housing removably disposed on a touch sensitive portion of the COP and at least one contact element disposed on an outer surface of the housing. The key is adapted to be inserted into the housing of the at least one rotary lock. The housing is adapted to rotate about the axis (X-X′) and retract along the axis (X-X′) towards the COP only in response to at least one first interlocking element of the housing coupling with at least one second interlocking element of a blade portion of the key. During rotation of the housing, the at least one contact element contacts at least one touch sensitive portion of the COP to form at least one capacitive coupling indicative of a selection of at least one predefined function of the elevator car.

According to a third aspect of the invention, a kit for the elevator car, is disclosed. The kit includes a rotary lock, a first key, and a second key. The rotary lock includes a housing having an inner surface adapted to receive a blade portion of the first key or the second key. Moreover, the housing includes an adhesive layer for removably fixing the rotary lock to the COP. The first key is adapted to be inserted into the rotary lock and the second key is adapted to be inserted into the rotary lock.

In an embodiment, the first key when coupled with the housing performs a first rotation of the housing.

Preferably, during the first rotation of the housing the at least one contact element contacts a first touch sensitive portion of the COP to form a first capacitive coupling.

Preferably, the first capacitive coupling is indicative of a selection of a first predefined function of the elevator car.

In yet another embodiment, the second key coupling with the housing performs a second rotation of the housing.

Preferably, during the second rotation of the housing, the at least one contact element contacts a second touch sensitive portion of the COP to form a second capacitive coupling.

Preferably, the second capacitive coupling is indicative of a selection of a second predefined function of the elevator car.

Additional advantages, features, and details of the invention result using the following description of exemplary embodiments and using drawings in which the same or functionally identical elements are provided having identical reference signs.

To further clarify advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

These and other features, aspects, and advantages of the present invention will become better understood when the following detailed description is read with reference to the accompanying drawings in which like characters represent like parts throughout the drawings, wherein:

### DESCRIPTION OF THE DRAWINGS

FIG. 1 illustrates a schematic side view of a key being inserted into a rotary lock of an elevator car, according to an embodiment of the present disclosure.

FIG. 2 illustrates a schematic side view of the key inserted into the rotary lock of the elevator car, according to an embodiment of the present disclosure; and FIG. 3 illustrates a schematic side view of the rotary lock rotated such that at least one contact element contacts at least one touch sensitive portion of a car operating panel (COP), according to an embodiment of the present disclosure.

### DETAILED DESCRIPTION

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

It should be understood at the outset that although illustrative implementations of embodiments are illustrated below, system and method may be implemented using any number of techniques. The disclosure should in no way be limited to the illustrative implementations, drawings, and techniques illustrated below, including the exemplary design and implementation illustrated and described herein, but may be modified within the scope of the appended claims along with their full scope of equivalents.

The term “some” as used herein is defined as “one, or more than one, or all.” Accordingly, the terms “one,” “more than one,” but not all” or “all” would all fall under the definition of “some.” The term “some embodiments” may refer to one embodiment or several embodiments or all embodiments. Accordingly, the term “some embodiments” is defined as meaning “one embodiment, or more than one embodiment, or all embodiments.”

The terminology and structure employed herein are for describing, teaching, and illuminating some embodiments and their specific features and elements and do not limit, restrict, or reduce the spirit and scope of the claims or their equivalents.

More specifically, any terms used herein such as but not limited to “includes,” “comprises,” “has,” “have” and grammatical variants thereof do not specify an exact limitation or restriction and certainly do not exclude the possible addition of one or more features or elements, unless otherwise stated, and must not be taken to exclude the possible removal of one or more of the listed features and elements, unless otherwise stated with the limiting language “must comprise” or “needs to include.”

Unless otherwise defined, all terms, and especially any technical and/or scientific terms, used herein may be taken to have the same meaning as commonly understood by one having ordinary skill in the art.

Embodiments will be described below in detail with reference to the accompanying drawings.

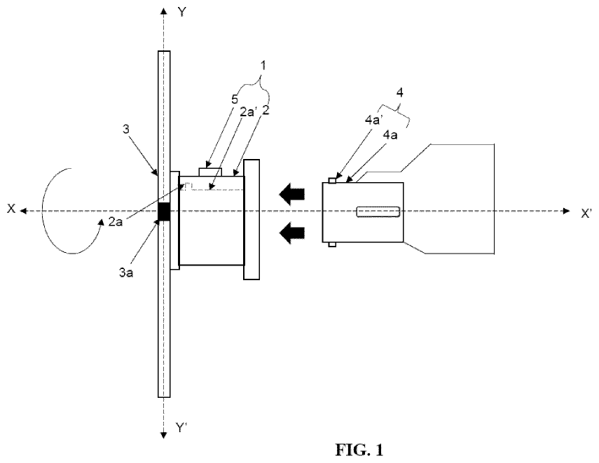

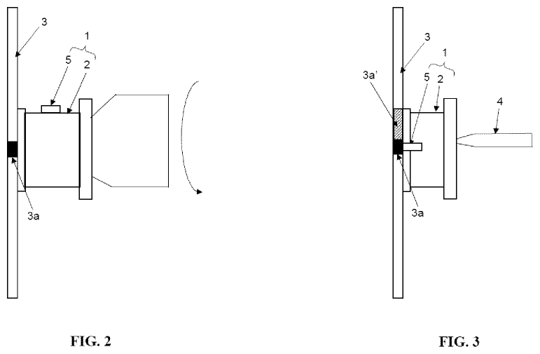

FIG. 1 illustrates a side view of a key 4 being inserted into a rotary lock 1 of an elevator car, according to an embodiment of the present disclosure. FIG. 2 illustrates a side view of the key 4 inserted into the rotary lock 1 of the elevator car, according to an embodiment of the present disclosure. Although the FIGS. 1-3 depict a barrel key as the type of key 4 being used, it must be appreciated that different type of keys apart from the barrel key type may be used. For example, the key 4 may include, but is not limited to, a flat key, a double sided key, a key for a warded lock, a key for a pin tumbler lock, a key for a wafer tumbler lock, a key for a disc tumbler lock, a key for a lever tumbler lock, a key for a magnetic keyed lock, etc. The rotary lock 1 may be deployed for a car operating panel (COP) 3 of the elevator car. The rotary lock 1 includes a housing 2 and at least one contact element 5 disposed on an outer surface of the housing 2. The housing 2 is removably disposed on a touch sensitive portion 3a of the COP 3. In an embodiment, the housing 2 is adapted to be removably fixed to the COP 3 through an adhesive.

The housing 2 includes an inner surface 2a′ adapted to receive a blade portion 4a of the key 4. In an embodiment, the inner surface 2a′ of the housing 2 defines at least one first interlocking element 2a adapted to couple with at least one second interlocking element 4a′ defined on the blade portion 4a of the key 4. As used herein, the at least one first interlocking element 2a and the at least one second interlocking element 4a′ are coupling elements like a male and a female connecting element in a mechanical joint. As such, the at least one first interlocking element 2a and the at least one second interlocking element 4a′ may be defined as a complementary protrusion and groove respectively. Alternatively, the at least one first interlocking element 2a and the at least one second interlocking element 4a′ may be defined as a complementary groove and protrusion respectively. When the at least one second interlocking element 4a′ mates with the at least one first interlocking element 2a, the coupled key 4 and the housing 2 of the rotary lock 1 are rotatable about an axis X-X′ perpendicular to an axis Y-Y′ of the COP 3 as exemplarily illustrated in FIG. 2.

The housing 2 of the rotary lock 1 is adapted to rotate about the axis X-X′ and retract along the axis X-X′ towards the COP 3 only in response to the at least one first interlocking element 2a of the housing 2 coupling with the at least one second interlocking element 4a′ of the blade portion 4a of the key 4. As used herein, the term “retract” refers to a movement of the housing 2 of the rotary lock 1 towards the COP 3 along the axis X-X′. Prior to the key 4 being inserted into the rotary lock 1, the housing 2 of the rotary lock 1 is at a fully extended position. When the key 4 is inserted into the rotary lock 1 and the at least one second interlocking element 4a′ couples with the at least one first interlocking element 2a of the housing 2, the housing 2 of the rotary lock 1 is compressed or retracts from the fully extended position to a retracted position such that the at least one contact element 5 touches the touch sensitive portion 3a of the COP 3 as shown in FIG. 3.

FIG. 3 illustrates a side view of the rotary lock 1 rotated such that the at least one contact element 5 contacts the at least one touch sensitive portion 3a of the car operating panel (COP) 3, according to an embodiment of the present disclosure. Preferably, the at least one contact element 5 is disposed on the outer surface of the housing 2. During rotation of the housing 2, the at least one contact element 5 contacts the at least one touch sensitive portion 3a of the COP 3 to form at least one capacitive coupling indicative of a selection of at least one predefined function of the elevator car.

As used herein, the term “the at least one contact element 5” refers to a conductive material such as a metal, a conductive ink, or a conductive resin capable of forming a capacitive coupling with the at least one touch sensitive portion 3a of the COP 3. In an embodiment, the “at least one contact element 5” is disposed on the outer surface of the housing 2 of the rotary lock 1. As such the key 4 can be manufactured without the at least one contact element 5. Advantageously, this feature reduces the cost of producing or replacing the key 4.

As used herein, the term “at least one predefined function” may be construed to include, but is not limited to, access to an independent hoist way, access to restricted floors, user control to control movement of the elevator car to specific floors, enabling maintenance functions such as recalling the elevator car to a specific floor or shutting off power to the elevator car, service functions such as priority service, in-car inspection, independent service, run/stop switch, code blue/medical emergency access, firefighters operation access, sabbath service, car light on/off/speed, and car fan on/off/speed switches. Since a single rotary lock 1 can be used to access multiple functions of the elevator car, the space requirements are advantageously minimized. Moreover, the replacement time of a faulty or malfunctioning rotary lock 1 is advantageously reduced since only the single rotary lock 1 may need to be replaced.

In an embodiment, if an improper key 4 is inserted, the at least one second interlocking element 4a′ does not couple with the at least one first interlocking element 2a of the housing 2. In one embodiment, when a matching key 4 is inserted into the rotary lock 1 and the at least one second interlocking element 4a′ couples with the at least one first interlocking element 2a of the housing 2 as shown in FIG. 1, the housing 2 of the rotary lock 1 is rotatable until the at least one contact element 5 reaches the touch sensitive portion 3a of the COP 3. However, the housing 2 of the rotary lock 1 cannot be pressed or retracted during this rotary motion till the at least one contact element 5 aligns with the touch sensitive portion 3a of the COP 3. Once the housing 2 of the rotary lock 1 aligns with the touch sensitive portion 3a of the COP 3, the housing 2 is pressed or retracted towards the COP 3 from the fully extended position. Consequently, the at least one contact element 5 contacts the at least one touch sensitive portion 3a of the COP 3 to form the at least one capacitive coupling indicative of the selection of the at least one predefined function of the elevator car.

In another embodiment, when the key 4 is inserted into the rotary lock 1 and the at least one second interlocking element 4a′ couples with the at least one first interlocking element 2a of the housing 2 as shown in FIG. 1, the housing 2 of the rotary lock 1 is immediately retractable towards the COP 3 and rotatable about the axis X-X′. This means the at least one contact element 5 is in contact with a second touch sensitive portion 3a′ of the COP 3 having a larger area than the touch sensitive portion 3a of the COP 3. Thus, the at least one contact element 5 continuously touches the COP 3 until the at least one contact element 5 reaches the touch sensitive portion 3a of the COP 3 as shown in FIG. 3. The COP 3 may be programmed to identify the continuous touch as the at least one capacitive coupling indicative of the selection of the at least one predefined function of the elevator car. For example, if a speed of a fan of the elevator car must be regulated, the area over which the at least one contact element 5 continuously touches the COP 3 is calibrated based on the degree of increase or degree of decrease in speed of the fan. For example, the second touch sensitive portion 3a′ may be calibrated to correspond to a faster speed of the fan than the touch sensitive portion 3a. Alternatively, the touch sensitive portion 3a may be calibrated to correspond to a FAN OFF function of the COP 3 and the second touch sensitive portion 3a′ of the fan may be calibrated to correspond to a FAN ON function of the COP 3.

In an embodiment, the degree of rotation of the housing 2 about the axis X-X′ may be preset based on a type of the inserted key 4. This means for a first type of key 4, the degree of rotation of the housing 2 may be restricted to less than 45 degrees about the axis (X-X′). Alternatively, for a second type of key 4, the degree of rotation of the housing 2 may be restricted to greater than 45 degrees but less than 90 degrees about the axis (X-X′) and so on. The at least one contact element 5 contacts the touch sensitive portion 3a of the COP 3 corresponding to the preset degree of rotation to form a capacitive coupling indicative of the selection of the predefined function associated with the type of the inserted key 4. A controller or microprocessor of the COP 3 may be configured to identify the selected predefined function and accordingly provide access to the selected predefined function. Advantageously, different keys 4 corresponding to different predefined functions of the elevator car for a single rotary lock 1 may therefore be designed.

The elevator car includes the at least one COP 3, the at least one rotary lock 1, and the key 4 shown in FIGS. 1-3. The at least one rotary lock 1 includes the housing 2 removably disposed on the touch sensitive portion 3a of the COP 3 and the at least one contact element 5 disposed on the outer surface of the housing 2. The key 4 is adapted to be inserted into the housing 2 of the at least one rotary lock 1. The housing 2 is adapted to rotate about the axis X-X′ and retract along the axis X-X′ towards the COP 3 only in response to the at least one first interlocking element 2a of the housing 2 coupling with the at least one second interlocking element 4a′ of the blade portion 4a of the key 4. During rotation of the housing 2, the at least one contact element 5 contacts at least one touch sensitive portion 3a of the COP 3 to form the at least one capacitive coupling indicative of the selection of the at least one predefined function of the elevator car.

Also disclosed is a kit for the elevator car including the rotary lock 1 shown and described in the detailed descriptions of FIGS. 1-3 and a plurality of keys 4. A first one of the keys 4 and a second one of the keys 4 are adapted to be inserted into the rotary lock 1 separately. The first one of the keys 4 coupling with the housing 2 performs a first rotation of the housing 2. During the first rotation of the housing 2, the at least one contact element 5 contacts a first touch sensitive portion 3a of the COP 3 to form a first capacitive coupling. In an embodiment, the first capacitive coupling is indicative of a selection of the first predefined function of the elevator car. Similarly, the second one of the keys 4 coupling with the housing 2 performs a second rotation of the housing 2. During the second rotation of the housing 2, the at least one contact element 5 contacts a second touch sensitive portion 3a of the COP 3 to form a second capacitive coupling. In an embodiment, the second capacitive coupling is indicative of a selection of a second predefined function of the elevator car. In an embodiment, the first rotation of the housing 2 is different from the second rotation of the housing 2.

Since a single rotary lock 1 can be used to access multiple functions of the elevator car, the space requirements are advantageously minimized. Moreover, the replacement time of a faulty or malfunctioning rotary lock 1 is advantageously reduced since only a single rotary lock 1 may need to be replaced. Moreover, the at least one contact element 5 is disposed on the outer surface of the housing 2 of the rotary lock 1 instead of the key 4. Advantageously, this feature reduces the cost of producing or replacing the key 4.

Since the degree of rotation of the housing 2 of the rotary lock 1 about the axis (X-X′) may be preset based on a type of the inserted key 4, ease of accessing multiple functions without compromising security is ensured. This could mean only authorized personnel are allowed to access a specific function of the elevator car. For example, for a first type of key 4, the degree of rotation of the housing 2 may be restricted to less than 45 degrees about the axis (X-X′). Alternatively, for a second type of key 4, the degree of rotation of the housing 2 may be restricted to greater than 45 degrees but less than 90 degrees about the axis (X-X′) and so on. Advantageously, different keys corresponding to different predefined functions of the elevator car for a single rotary lock may therefore be designed. As such, the rotary lock 1 permits quick and convenient access to the predefined functions associated with a maintenance session, a repair session, or an emergency session of the elevator car, with minimal space requirements.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

Finally, it should be noted that terms such as “comprising,” “having,” etc. do not preclude other elements or steps and terms such as “a” or “an” do not preclude a plurality. Furthermore, it should be noted that features or steps that have been described with reference to one of the above embodiments can also be used in combination with other features or steps of other embodiments described above. Reference signs in the claims should not be considered to be limiting.

1.15. (canceled)

16. A rotary lock for a car operating panel (COP) of an elevator car, the rotary lock comprising:
a housing removably disposed on a touch sensitive portion of the COP, the housing comprising an inner surface adapted to receive a blade portion of a key; and
at least one contact element disposed on an outer surface of the housing,
wherein during rotation of the housing, the at least one contact element contacts at least one touch sensitive portion of the COP to form at least one capacitive coupling indicative of a selection of at least one predefined function of the elevator car.

17. The rotary lock according to claim 16, wherein the housing is rotatable about an axis (X-X′) perpendicular to an axis (Y-Y′) of the COP.

18. The rotary lock according to claim 16, wherein the inner surface of the housing defines at least one first interlocking element adapted to couple with at least one second interlocking element defined on the blade portion of the key.

19. The rotary lock according to claim 18, wherein the housing is adapted to rotate about an axis (X-X′) and retract along the axis (X-X′) towards the COP only in response to the at least one first interlocking element of the housing coupling with the at least one second interlocking element of the blade portion of the key.

20. The rotary lock according to claim 16, wherein the housing is adapted to be removably fixed to the COP through an adhesive.

21. The rotary lock according to claim 17, wherein a degree of rotation of the housing about the axis (X-X′) is preset based on a type of the inserted key.

22. The rotary lock according to claim 21, wherein the at least one contact element contacts the touch sensitive portion of the COP corresponding to the preset degree of rotation to form a capacitive coupling indicative of the selection of the predefined function associated with the type of the inserted key.

23. An elevator car comprising:
at least one car operating panel (COP);
at least one rotary lock comprising a housing removably disposed on a touch sensitive portion of the COP and at least one contact element disposed on an outer surface of the housing; and
a key adapted to be inserted into the housing of the at least one rotary lock,
wherein the housing is adapted to rotate about the axis (X-X′) and retract along the axis (X-X′) towards the COP only in response to at least one first interlocking element of the housing coupling with at least one second interlocking element of a blade portion of the key,
and wherein during rotation of the housing the at least one contact element contacts at least one touch sensitive portion of the COP to form at least one capacitive coupling indicative of a selection of at least one predefined function of the elevator car.

24. A kit for the elevator car, the kit comprising:
a rotary lock comprising a housing having an inner surface adapted to receive a blade portion of at least one of a first key and a second key, wherein the housing comprises an adhesive layer for removably fixing the rotary lock to a car operating panel (COP);
the first key adapted to be inserted into the rotary lock; and
the second key adapted to be inserted into the rotary lock.

25. The kit for the elevator car according to claim 24, wherein the first key coupling with the housing performs a first rotation of the housing.

26. The kit for the elevator car according to claim 25, wherein during the first rotation of the housing the at least one contact element contacts a first touch sensitive portion of the COP to form a first capacitive coupling.

27. The kit for the elevator car according to claim 26, wherein the first capacitive coupling is indicative of a selection of a first predefined function of the elevator car.

28. The kit for the elevator car according to claim 24, wherein the second key coupling with the housing performs a second rotation of the housing.

29. The kit for the elevator car according to claim 28, wherein during the second rotation of the housing the at least one contact element contacts a second touch sensitive portion of the COP to form a second capacitive coupling.

30. The kit for the elevator car according to claim 29, wherein the second capacitive coupling is indicative of a selection of a second predefined function of the elevator car.
